(19) United States
(12) Patent Application Publication
(10) Pub. No.: US 2021/0345634 A1
(43) Pub. Date: Nov. 11, 2021

(54) DISSOLVING COFFEE BEADS

(71) Applicant: Christopher Burns, Longview, WA (US)

(72) Inventor: Christopher Burns, Longview, WA (US)

(21) Appl. No.: 17/315,245

(22) Filed: May 7, 2021

Related U.S. Application Data
(60) Provisional application No. 63/021,667, filed on May 7, 2020.

(51) Int. Cl. A23F 5/24; A23F 5/40; A23F 5/26; B65D 65/46; B65D 25/22; B65D 25/54; B65D 85/00; B65D 25/52

(52) U.S. Cl. CPC A23F 5/243; A23F 5/40; A23F 5/267; B65D 65/46; B65D 2203/02; B65D 25/54; B65D 85/70; B65D 25/52; B65D 25/22

(57) ABSTRACT

A coffee capsule dispensing assembly that includes at least one substantially gelatin casing capsule or composite which contains a coffee concentrate or composite or coffee enhancing substance. The gelatin casing capsule with a hydrolyzed collagen gelatin portion is designed to dissolve in an aqueous solution. A housing assembly with a distal end and a proximal end is designed to contain the at least one gelatin casing capsule. A depressible button assembly is disposed substantially at the proximal end of the housing assembly and is designed to advance the at least one gelatin casing capsule toward the distal end of the housing assembly. A latch and release assembly at the distal end of the housing assembly is designed to singularly release the at least one gelatin casing capsule when the at least one gelatin casing capsule is advanced by the depressible button assembly.

### CLAIM OF PRIORITY

This application claims priority to and the benefit of U.S. Provisional application with Ser. No. 63/021,667, filed on May 7, 2020, with the title “Dissolving Coffee Beads”, which is incorporated herein by reference in its entirety.

### FIELD OF THE INVENTION

The inventive concept relates generally to dissolving coffee ingredients.

### BACKGROUND

Currently, there are a number of solutions for making coffee. One of these solutions attempts to utilize ground coffee beans in a drip coffee maker, but this solution fails to meet the needs of the market because grinding coffee beans can be messy and time consuming as a user is waiting for one cup to be brewed. Another solution attempts to utilize pour-over coffee, but this solution is similarly unable to meet the needs of the market because pour-over coffee makes only a small amount of coffee. Still another solution for a quick cup of coffee is to have a coffee barista prepare it for you, but this solution also fails to meet market needs because buying fresh coffee everyday can be expensive while still being time consuming as you wait for ordering and preparation. Still another solution seeks convenient packaging such as plastic coffee pods for instant coffee drip preparations, but this solution can be wasteful because the packaging must be discarded and portability of a hot water dispenser is still a problem. Therefore, there currently exists a need in the market for an inventive concept that is convenient, affordable, portable and eliminates plastic coffee pods or long waits at the coffee shop.

### SUMMARY OF THE INVENTION

Herein is provided a dissolvable coffee capsule and dispensing assembly having at least one substantially gelatin casing assembly, the at least one gelatin casing assembly designed to contain a substantially coffee or coffee enhancing substance therein, the at least one gelatin casing assembly designed to dissolve in a substantially aqueous solution. The dispensing assembly includes a housing assembly having a distal end and a proximal end and is designed to contain the at least one gelatin casing assembly. A depressible button assembly is disposed at or near the proximal end of the housing assembly and is designed, when depressed, to advance the at least one gelatin casing assembly toward the distal end of the housing assembly. A latch and release assembly is disposed at or about the distal end of the housing assembly and is designed to singularly release the at least one gelatin casing assembly when the at least one gelatin casing assembly is advanced by the depressible button assembly.

In one embodiment of the dissolvable coffee capsule and dispensing assembly, the depressible button assembly is coupled with a lock and release assembly, the lock and release assembly designed, when in a locked position, to prevent the depressible button assembly from being depressed. In a related embodiment, the coffee capsule is formed without the gelatin casing assembly using other known food binders and food compression and compaction techniques to form the dissolvable capsule.

In one embodiment of the coffee capsule and dispensing assembly, a clip assembly is disposed outwardly on the housing assembly and designed to couple the housing assembly to a second element thereon.

In one embodiment of the coffee capsule and dispensing assembly, the housing assembly holds up to five gelatin casing assemblies.

In one embodiment of the dissolvable coffee capsule and dispensing assembly, the gelatin casing assembly contains at least one or more ingredients from a group consisting of: coffee, coffee extract or concentrate, creamer, sweeteners, and flavors. The contents of the gelatin casing assembly may be denoted by at least one imprint disposed on the gelatin casing assembly. The contents of the gelatin casing assembly may be color coded. The contents of the housing assembly may be coded by at least one or more of color and imprint disposed on at least one or more of the depressible button, the latch and release assembly, and the housing assembly itself.

In one embodiment of the coffee capsule and dispensing assembly, a transparent viewing window member disposed on a side portion of the housing assembly is designed to display the contents therein.

In one embodiment of the coffee capsule and dispensing assembly, the at least one gelatin casing assembly may be loaded into the housing assembly one at a time. In a second embodiment, the at least one gelatin casing assembly may be loaded into the housing assembly assisted by a sleeve or magazine assembly.

In one embodiment of the coffee capsule and dispensing assembly, the gelatin casing assembly may be used directly inside a coffee brewing assembly in place of a plastic cup assembly by being mounted substantially in the assembly designed to contain the plastic cup assembly.

It would be advantageous to have a coffee capsule and dispensing assembly that is eco-friendly and that is waste-free. Still further, it would be advantageous to have a coffee capsule and dispensing assembly that is reusable. Still further, when compared to preparing coffee grounds, using a barista, or using plastic or eco-friendly coffee pods, the inventive concept can be easily used anywhere with no trailing waste products. In contrast, a barista needs a café, and coffee pods require a brewer that must be plugged in. The inventive dispenser is small, portable, and the coffee capsule and dispensing assembly just needs water to create a beverage. In related embodiments, other dissolvable capsules can be formed from powders or extracts such as teas, milk or powdered drinks (such as Powerade®), baby formula or senior care formulas (such as Ensure®) can be readily dispensed from the inventive dispensing assembly and mixed with an aqueous substance.

The inventive concept, by eliminating plastic coffee pods, advances the art by creating a more ideal solution delivering the intended benefit to the user while reducing a significant drawback of increased environmental waste and disposal challenges.

The inventive concept advantageously fills the aforementioned deficiencies by providing dissolving coffee beads (or other compacted substances), which provides a fast and hassle-fee way to make coffee. The inventive concept has a reloadable dispenser and may have multiple flavors. The inventive concept fulfills the need for eco-friendly instant coffee distinct from dissolvable powders or freeze-dried granules but with improved taste and improved shelf life over current coffee pods.

Among other things, it is an advantage of the inventive concept to provide dissolving coffee beads that do not suffer from problems or deficiencies associated with prior solutions. It is still further an advantage of the inventive concept to be universal. Still further, the inventive concept may have flavor imprints.

The inventive concept now will be described more fully hereinafter with reference to the accompanying drawings, which are intended to be read in conjunction with both this summary, the detailed description and any preferred and/or particular embodiments specifically discussed or otherwise disclosed. This inventive concept may, however, be embodied in many different forms and should not be construed as limited to the embodiments set forth herein; rather, these embodiments are provided by way of illustration only and so that this disclosure will be thorough, complete, and will fully convey the full scope of the inventive concept to those skilled in the art.

### BRIEF DESCRIPTION OF THE DRAWINGS

FIG. 1 illustrates a top side view of a capsule dispenser.

FIG. 2 illustrates a bottom side view of the capsule dispenser.

FIG. 3 illustrates a front side view of the dispenser.

FIG. 4 illustrates a left side view of the dispenser.

FIG. 5 illustrates a right side view of the dispenser.

FIG. 6 illustrates a rear or back side view of the dispenser.

FIG. 7 illustrates a perspective view of the dispenser.

FIGS. 8A and 8B illustrate external and internal perspective views, respectively, of the dispenser.

FIGS. 9A and 9B illustrate external and internal views, respectively, of a gelatin casing assembly.

FIG. 10 illustrates an interior or inside view of the gelatin casing assembly.

FIG. 11 illustrates glycine, proline, and hydroxyproline of hydrolyzed collagen chemical symbols.

FIG. 12A-12C illustrates a method of using the dispenser and gelatin casing assembly.

### DETAILED DESCRIPTION OF THE INVENTION

Following are more detailed descriptions of various related concepts related to, and embodiments of, methods and apparatus according to the present disclosure. It should be appreciated that various aspects of the subject matter introduced above and discussed in greater detail below may be implemented in any of numerous ways, as the subject matter is not limited to any particular manner of implementation. Examples of specific implementations and applications are provided primarily for illustrative purposes.

The inventive concept includes substantially waste-free dissolvable coffee beads or capsules. In one example embodiment, the coffee beads or capsules are made substantially from gelatin, which is a translucent, colorless, flavorless food ingredient, derived from collagen taken from animal body parts or synthesized. Gelatin is brittle when dry and gummy when moist. It may also be refereed to as hydrolyzed collagen, collagen hydrolysate, gelatin hydrolysate, hydrolyzed gelatin, and collagen peptides after it has undergone hydrolysis. It is commonly used as a gelling agent in food, medication, drug, and vitamin capsules and is herein used to contain the substantially coffee, coffee extract or coffee enhancing substance that would be dissolved to release the coffee or coffee enhancing substance to make or enhance or create a coffee beverage. Substances containing gelatin or functioning in a similar way, such as tapioca starch soft gels, are included or are within the gelatin casing assembly.

Gelatin is an irreversibly hydrolyzed form of collagen, wherein the hydrolysis reduces protein fibrils into smaller peptides. Depending on the physical and chemical methods of denaturation, the molecular weight of the peptides falls within a broad range.

Hydrolyzed collagen may predominantly be glycine, proline, and hydroxyproline, which together may represent around 50% of the total amino acid content. Gelatin readily dissolves in hot water and sets to a gel on cooling as when the at least one gelatin casing assembly is disposed within the housing assembly.

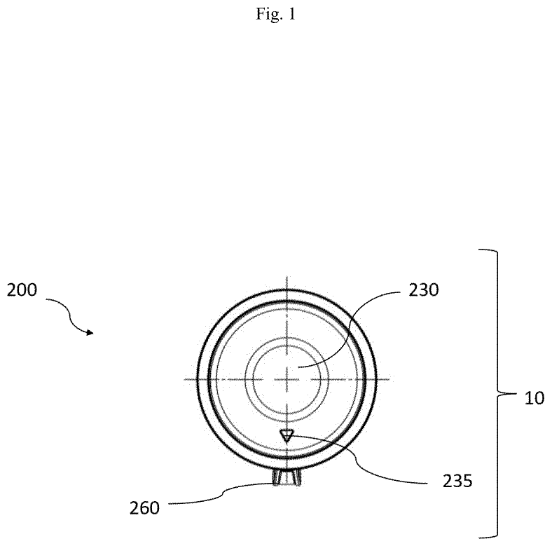

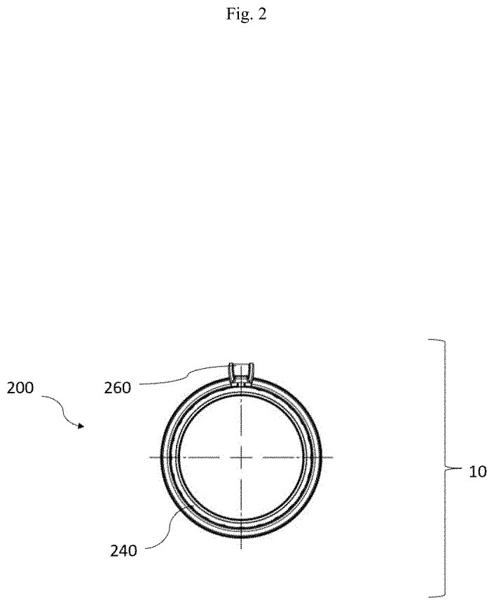

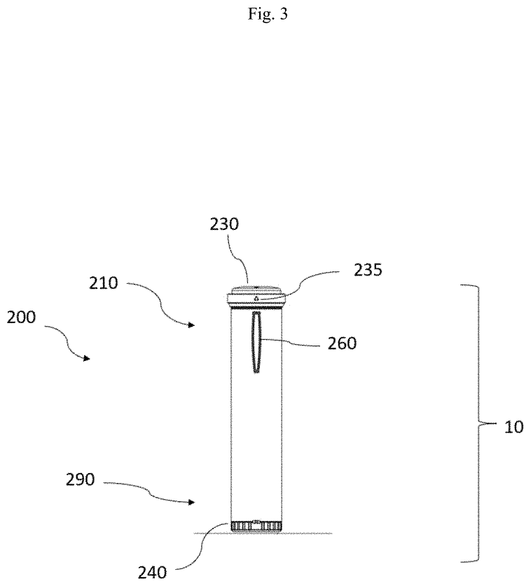

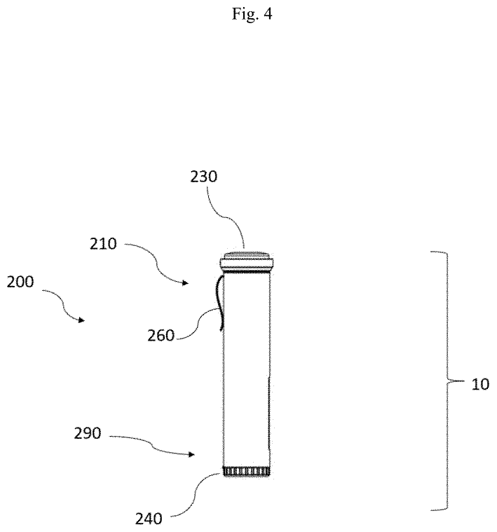

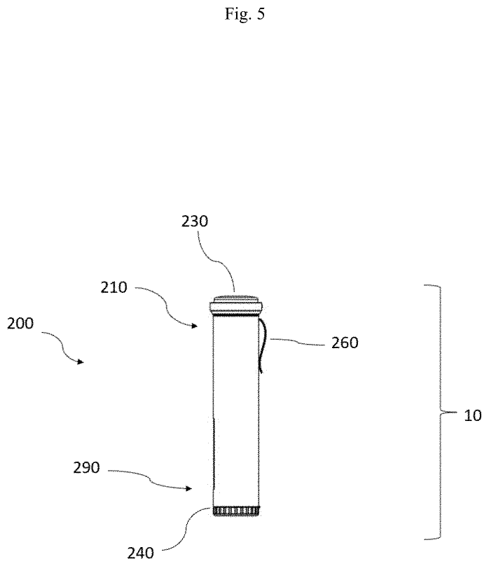

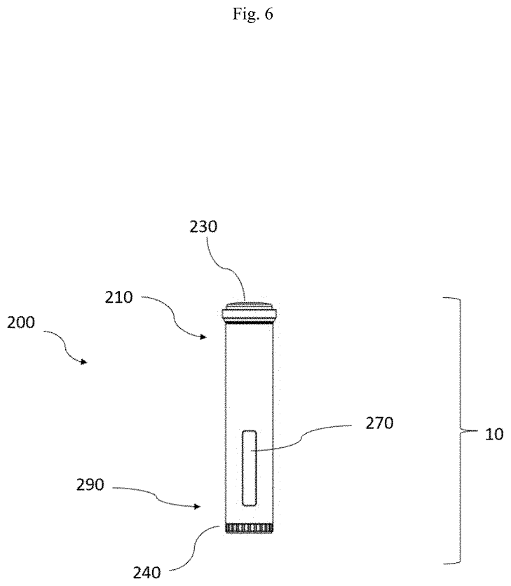

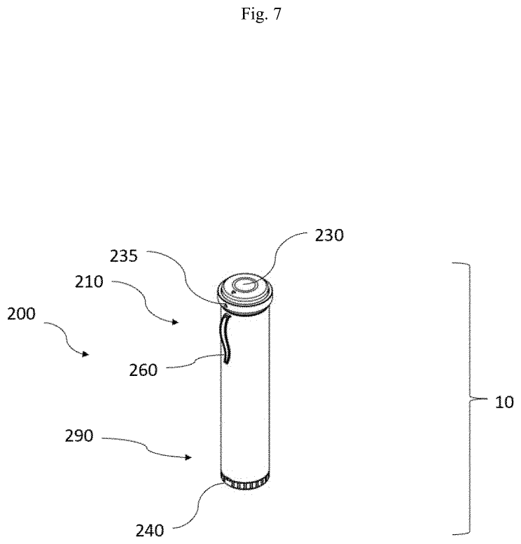

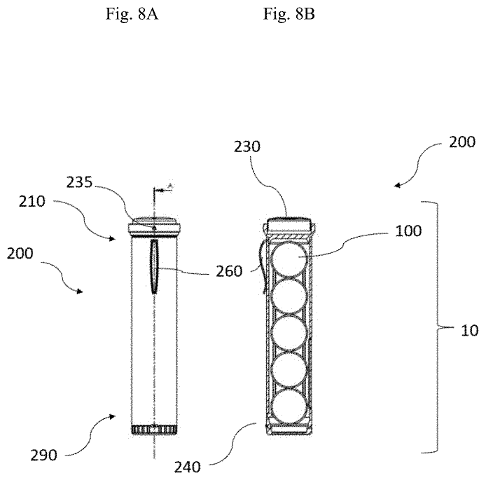

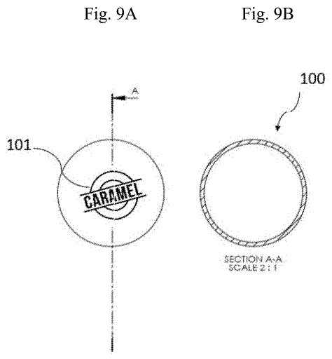

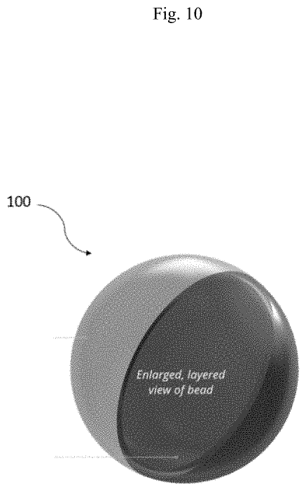

Referring to the figures, FIGS. 1-10 illustrate at least one substantially gelatin casing composite or capsule 100 that is configured to contain a coffee concentrate or coffee enhancing substance therein, is designed to dissolve in an aqueous solution and is dispensed with a coffee capsule dispensing assembly 10. Dispensing assembly 10 includes a housing assembly 200 with a distal end 290 and a proximal end 210 is designed to contain the at least one gelatin casing capsule 100. A depressible button assembly 230 is disposed at or about the proximal end 210 of the housing assembly 200 and is designed to advance the at least one gelatin casing assembly 100 toward the distal end 290 of the housing assembly 200.

In this example embodiment, a latch and release assembly 240 is disposed at or about the distal end 290 of the housing assembly 200 and is designed to singularly release the at least one gelatin casing assembly 100 when the at least one gelatin casing assembly 100 is advanced by the depressible button assembly 230. The housing assembly 200 is coupled with a lock and release assembly 235 to prevent the depressible button assembly 230 from being unintentionally depressed. A clip assembly 260 is disposed outwardly on the housing assembly 200 and is designed to couple the housing assembly 200 to a carrying element thereon.

In this example embodiment of the coffee capsule and dispensing assembly 10, the gelatin casing capsule 100 contains at least one or more ingredients from a group comprised of: coffee, creamer, sweeteners, and flavors. In this example embodiment of the coffee capsule and dispensing assembly 10, the contents of the gelatin casing capsule 100 are denoted by at least one imprint 101 disposed on the gelatin casing capsule 100. In this example embodiment of the coffee capsule and dispensing assembly 10, the gelatin casing capsules 100 are color coded.

In this example embodiment of the coffee capsule and dispensing assembly 10, the contents of the housing assembly 200 are coded by at least one or more of color and imprint disposed on at least one or more of the depressible button 230, the latch and release assembly 240, and the housing assembly 200.

In this example embodiment of the coffee capsule and dispensing assembly 10, the gelatin casing capsule. a transparent viewing window member 270 is disposed on a side portion of the housing assembly 200 and is designed to display the contents therein.

In this example embodiment of the coffee capsule and dispensing assembly 10, the diameter of each gelatin casing capsule 100 is substantially one inch.

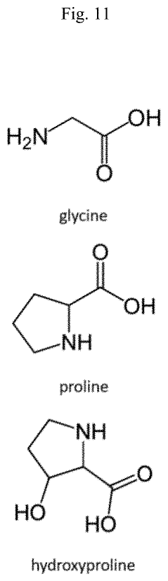

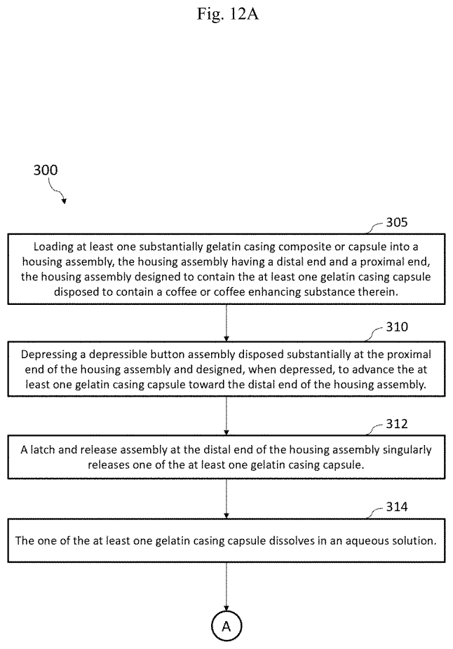

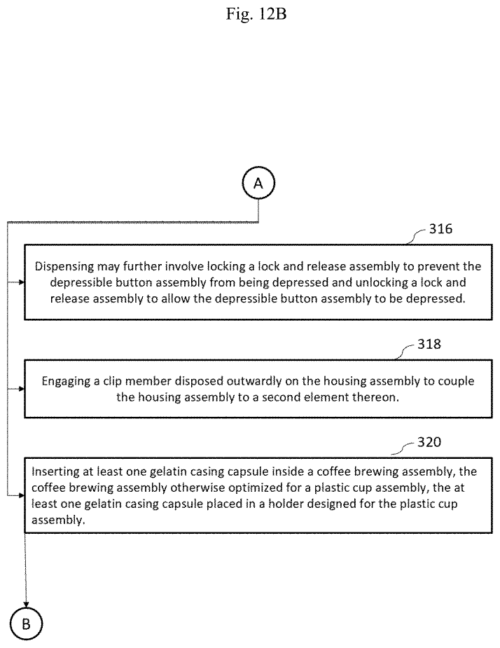

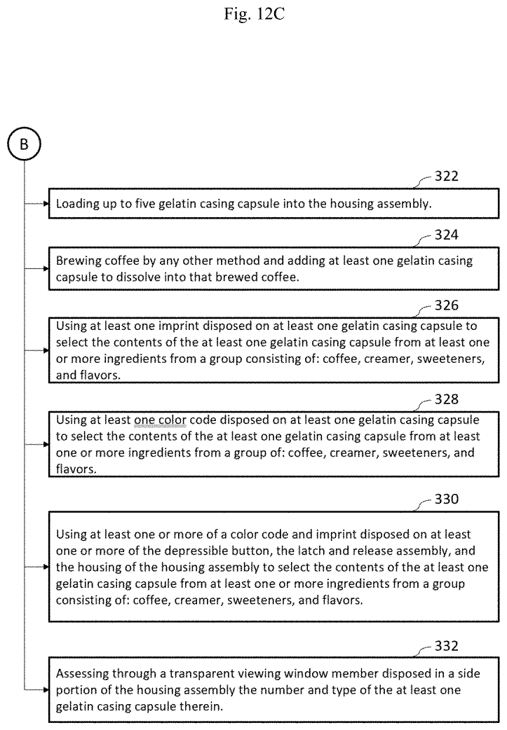

Referring now to FIGS. 11 and 12, FIG. 11 illustrates glycine, proline, and hydroxyproline, together representing about 40% to 60% of the total amino acid content of each gelatin portion of each gelatin casing capsule 100.

FIG. 12A-12C illustrates a method for coffee capsule dispensing 300, the method including the steps of loading at step 305 at least one substantially gelatin casing capsule 100 into a housing assembly 200, the housing assembly having a distal end 290 and a proximal end 210, the housing assembly designed to contain the at least one gelatin casing capsule 100 disposed to contain a coffee composite or concentrate or a coffee enhancing substance therein. Depressing at step 310 a depressible button assembly 230 disposed at or about the proximal end of the housing assembly and designed, when depressed, to advance the at least one gelatin casing capsule toward the distal end 290 of the housing assembly 200. Releasing at step 312 with a latch and release assembly 240 at the distal end 290 of the housing assembly 200 which singularly releases one of the at least one gelatin casing capsule 100. At step 314, dissolving the one of the at least one gelatin casing assembly dissolves in an aqueous solution.

The method for coffee capsule dispensing 300 may further including the step 316 of locking a lock and release assembly 235 to prevent the depressible button assembly 230 from being depressed and unlocking a lock and release assembly to allow the depressible button assembly to be depressed. The method for coffee capsule dispensing 300 may further include the step 318 of engaging a clip member 260 disposed outwardly on the housing assembly to couple the housing assembly to a second element thereon. The method for coffee capsule dispensing 300 may further include the step 320 of inserting at least one gelatin casing assembly inside a coffee brewing assembly, the coffee brewing assembly otherwise optimized for a plastic cup assembly, the at least one gelatin casing assembly placed in a holder designed for the plastic cup assembly.

The method for coffee capsule dispensing 300 may further include step 322 of loading up to five gelatin casing assemblies into the housing assembly 200.

The method for coffee capsule dispensing may further include the step 324 of brewing coffee by any other method and adding at least one gelatin casing assembly to dissolve into that brewed coffee.

The method for coffee capsule dispensing 300 may further include the step 326 of using at least one imprint disposed on at least one gelatin casing assembly to select the contents of the at least one gelatin casing assembly from at least one or more ingredients from a group of: coffee, creamer, sweeteners, and flavors.

The method for coffee capsule dispensing 300 may further include the step 328 of using at least one color code disposed on at least one gelatin casing assembly to select the contents of the at least one gelatin casing assembly from at least one or more ingredients from a group of: coffee, creamer, sweeteners, and flavors.

The method for coffee capsule dispensing 300 may further include the step 330 of using at least one or more of a color code and imprint disposed on at least one or more of the depressible button, the latch and release assembly, and the housing of the housing assembly to select the contents of the at least one gelatin casing assembly from at least one or more ingredients from a group of: coffee, creamer, sweeteners, and flavors.

The method for coffee capsule dispensing 300 may further include the step 332 of assessing through a transparent viewing window member disposed in a side portion of the housing assembly the number and type of the at least one gelatin casing assembly therein.

The following patents are incorporated by reference in their entireties: U.S. Pat. Nos. 2,889,226, 5,882,717, and 5,900,416.

While the inventive concept has been described above in terms of specific embodiments, it is to be understood that the inventive concept is not limited to these disclosed embodiments. Upon reading the teachings of this disclosure, many modifications and other embodiments of the inventive concept will come to mind of those skilled in the art to which this inventive concept pertains, and which are intended to be and are covered by both this disclosure and the appended claims. It is indeed intended that the scope of the inventive concept should be determined by proper interpretation and construction of the appended claims and their legal equivalents, as understood by those of skill in the art relying upon the disclosure in this specification and the attached drawings.

1. A coffee capsule and dispensing assembly comprising:
at least one substantially gelatin casing capsule or composite, the at least one gelatin casing capsule disposed to contain a coffee concentrate or coffee enhancing substance therein, the at least one gelatin casing capsule adapted to dissolve in an aqueous solution;
a housing assembly with a distal end and a proximal end, the housing assembly adapted to contain the at least one gelatin casing assembly;
a depressible button assembly disposed at or about the proximal end of the housing assembly and adapted, when depressed, to advance the at least one gelatin casing capsule toward the distal end of the housing assembly; and
a latch and release assembly disposed at or about the distal end of the housing assembly and adapted to singularly release the at least one gelatin casing capsule or composite when the at least one gelatin casing capsule is advanced by the depressible button assembly.

2. The coffee capsule and dispensing assembly of claim 1 wherein the depressible button assembly is coupled with a lock and release assembly, the lock and release assembly adapted, when in a locked position, to prevent the depressible button assembly from being depressed.

3. The coffee capsule and dispensing assembly of claim 1 wherein a clip assembly is disposed outwardly on the housing assembly and adapted to couple the housing assembly to a second element thereon.

4. The coffee capsule and dispensing assembly of claim 1 wherein the capsules contained within the housing assembly are coded by at least one or more of color and imprint disposed on at least one or more of the depressible button, the latch and release assembly, and the housing assembly.

5. The coffee capsule and dispensing assembly of claim 1 wherein the housing assembly further includes a transparent viewing window member disposed on a side portion of the housing assembly adapted to display the contents therein.

6. The coffee capsule and dispensing assembly of claim 1 wherein the housing assembly holds up to five gelatin casing capsules.

7. A coffee capsule for a dispensing assembly or apparatus comprising:
at least one substantially gelatin casing capsule or composite, the at least one gelatin casing capsule disposed to contain a coffee concentrate or coffee enhancing substance therein, the at least one gelatin casing capsule adapted to dissolve in an aqueous solution;
a gelatin portion of the gelatin casing capsule including an irreversibly hydrolyzed form of collagen, wherein the hydrolysis reduces protein fibrils into smaller peptides, wherein the hydrolyzed collagen includes substantially a mixture of glycine, proline, and hydroxyproline, together representing substantially between 40% and 60% of the total amino acid content of the gelatin portion; and
the gelatin casing assembly containing at least one or more ingredients from a group of: coffee, creamer, sweeteners, and flavors.

8. The coffee capsule for a dispensing assembly of claim 7 wherein the ingredients of the gelatin casing capsule are denoted by at least one imprint disposed on the gelatin casing capsule.

9. The coffee capsule for a dispensing assembly of claim 7 wherein the ingredients of the gelatin casing capsule are color coded.

10. The coffee capsule for a dispensing assembly of claim 7 wherein the diameter of each gelatin casing capsule is substantially one inch.

11. A method for coffee capsule dispensing, the method comprising the steps of:
loading at least one substantially gelatin casing capsule or composite into a housing assembly, the housing assembly having a distal end and a proximal end, the housing assembly adapted to contain the at least one gelatin casing capsule disposed to contain a coffee concentrate or coffee enhancing substance therein;
depressing a depressible button assembly disposed substantially at the proximal end of the housing assembly and adapted, when depressed, to advance the at least one gelatin casing capsule toward the distal end of the housing assembly;
a latch and release assembly at the distal end of the housing assembly singularly releasing one of the at least one gelatin casing capsule; and
the one of the at least one gelatin casing capsule dissolving in an aqueous solution.

12. The method for coffee capsule dispensing of claim 11, the method further including the step of locking a lock and release assembly to prevent the depressible button assembly from being depressed and unlocking a lock and release assembly to allow the depressible button assembly to be depressed.

13. The method for coffee capsule dispensing of claim 11, the method further including the step of engaging a clip member disposed outwardly on the housing assembly to couple the housing assembly to a second element thereon.

14. The method for coffee capsule dispensing of claim 11, the method further including the step of inserting at least one gelatin casing capsule inside a coffee brewing assembly, the coffee brewing assembly otherwise optimized for a plastic cup assembly, the at least one gelatin casing capsule placed in a holder designed for the plastic cup assembly.

15. The method for coffee capsule dispensing of claim 11, the method further including the step of loading a plurality of gelatin casing capsules into the housing assembly.

16. The method for coffee capsule dispensing of claim 11, the method further including the step of brewing coffee by any other method and adding at least one gelatin casing capsule to dissolve into that brewed coffee.

17. The method for coffee capsule dispensing of claim 11, the method further including the step of using at least one imprint disposed on at least one gelatin casing capsule to select the contents of the at least one gelatin casing capsule from at least one or more ingredients from a group consisting of: coffee, creamer, sweeteners, and flavors.

18. The method for coffee capsule dispensing of claim 11, the method further including the step of using at least one color code disposed on at least one gelatin casing capsule to select the ingredients of the at least one gelatin casing capsule from at least one or more ingredients from a group consisting of: coffee, creamer, sweeteners, and flavors.

19. The method for coffee capsule dispensing of claim 11, the method further including the step of using at least one or more of a color code and imprint disposed on at least one or more of the depressible button, the latch and release assembly, and the housing assembly of the housing assembly to select the ingredients of the at least one gelatin casing capsule from at least one or more ingredients from a group consisting of: coffee, creamer, sweeteners, and flavors.

20. The method for coffee capsule dispensing of claim 11, the method further including the step of assessing through a transparent viewing window member disposed on a side portion of the housing assembly the number and type of the at least one gelatin casing capsule disposed therein.
